(19) United States
(12) Patent Application Publication
(10) Pub. No.: US 2024/0354826 A1
(43) Pub. Date: Oct. 24, 2024

(54) SYSTEM AND METHOD FOR DYNAMIC SWITCHING BETWEEN SEARCH AND CHAT

(71) Applicant: Klevu Oy, Espoo (FI)

(72) Inventors: Niraj Aswani, St Albans (GB); Nilay Oza, London (GB)

(21) Appl. No.: 18/639,858

(22) Filed: Apr. 18, 2024

Related U.S. Application Data
(60) Provisional application No. 63/496,857, filed on Apr. 18, 2023.

(51) Int. Cl. G06Q 30/0601; G06F 3/16; G06F 16/332; H04L 67/50

(52) U.S. Cl. CPC G06Q 30/0625; G06F 3/167; G06F 16/3329; G06Q 30/0631; G06Q 30/0641; H04L 67/535

(57) ABSTRACT

Disclosed below is a system and method for facilitating search or browse mode and chat mode in an online ecommerce platform. Further, it allows users to switch between both the modes anytime. This enables a user to get product specific answers quickly while browsing, by switching from browse mode to chat mode and asking the chat bot. With the additional information in hand, the user can make a better decision while shopping.

### TECHNICAL FIELD

Various embodiments are directed to systems and methods disclosure relates generally to computer systems and processes for online ecommerce, and, more particularly, to search engines for online ecommerce and conversational artificial intelligence chat bots used in online ecommerce.

### BACKGROUND

E-Commerce has grown exponentially in the recent times with an ever growing number of online shopping transactions taking place every second through ecommerce storefronts. People prefer to search for their desired products online, from the comfort of their homes, rather than checking out the products at a physical store. Currently there exists multiple ecommerce storefronts and all of them are trying to provide as closest experience as possible to the customer as a real store. However, all of them are either providing a search option within their ecommerce store for the users to search for their required products or providing a response based on a conversational chat bot using AI.

In a real store a customer can browse through the available products on display and also engage in a conversation with the executives present in the store for more details regarding each of the products. But in an online ecommerce platform, the users are either provided with an option to search and/or browse through the available products wherein the information regarding the products are limited to what is available within the product page. Another option available for the customers on an online ecommerce portal is to engage in a conversation with an conversational chat bot, for which the customer has to open a separate chat session and give all the details of the specific product or concern.

While searching on online ecommerce platforms or browsing digital catalogues or even physically in an offline shop, shoppers often feel a need to talk to an agent to ask a few questions. However, unlike in a physical offline shop where customer executives are present to answer the questions, currently, in online ecommerce platforms, there exists no solution wherein the user can perform both a search and/or browse and also chat with a conversational chat bot. Further, there is no currently existing solution wherein the conversational chat bot provides contextual question prompts and answers in the context of a user's search, just like how an executive within a physical store would provide.

In the light of the above-mentioned shortcomings associated with existing search or browse feature and chat bots in online ecommerce, it is highly desirable to have a system which could enable both search or browse feature and chat bots along with dynamically switching between the same as per the customers' requirements.

### SUMMARY

Embodiments of the present disclosure present technological improvements as solutions to one or more of the above-mentioned technical problems recognized by the inventor in conventional systems.

The present invention discloses a system and method for enabling standard browse mode and a chat mode using a conversational Artificial Intelligence enabled chat bot, in an online ecommerce platform. Further disclosed below is a system and method for facilitating users to dynamically switch between browse mode and chat mode. Additionally, the present disclosure keeps track of the user history while browsing through the ecommerce platform and accordingly teaches the conversational Artificial Intelligence enabled chat bot, to prompt relevant questions and answers while the user is in chat mode.

In the primary embodiment of the present invention, it discloses a system and method comprising a hardware processor communicably coupled via a communication network with one or more user devices and a memory device wherein the processor enables a user to browse through an online ecommerce platform and also chat with a conversational Artificial Intelligence enabled chat bot via a graphical user interface present on the one or more user devices. Additionally, the disclosed system and method enables to dynamically switch between the browse mode and the chat mode using the graphical user interface.

In additional aspects of the present invention, the system and method Single platform for saving towards a common goal, unlike existing solutions where people have to use multiple portions/sections of the online ecommerce portal for browsing products and for chat feature. Further, the system and methods disclosed herein has updated context of the user's browsing history, which enables the chat function to be user specific and also optionally product specific as well.

Additional aspects, advantages, features and objects of the present disclosure would be made apparent from the and the detailed description of the illustrative embodiments construed in conjunction with the appended claims that follow.

While the systems and methods are illustrated by use of computer enabled embodiments and applications, they are equally applicable to virtually any portable or mobile communication device, including for example, computers laptops and mobile phones.

### BRIEF DESCRIPTION OF THE DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts the block diagram of the exemplary system as per the present disclosure.

FIG. 2 is a flow chart depicting the method steps of the present invention.

FIG. 3 depicts a sample dynamic HTML page displayed on the graphical user interface of the smartphone before activating the chat mode as per the present disclosure.

FIG. 4 depicts a sample dynamic HTML page displayed on the graphical user interface of the smartphone after activating the chat mode as per the present disclosure.

It will be appreciated that the drawings illustrated herein are for representation purposes only and do not intend to limit the scope of the present disclosure, and actual implementation of the present disclosure may be viewed substantially differently.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present invention discloses a system and method for dynamically switching between browse or search mode and a chat mode using a conversational agent, in an online ecommerce platform. Further disclosed below is a system and method for facilitating users to dynamically switch between browse mode and chat mode. In a primary embodiment of the present invention, it discloses a system and method for dynamic switching between browse and chat modes in an online ecommerce platform, comprising a hardware processor communicably coupled via a communication network with one or more user devices and a memory device wherein the processor enables a user to browse through an online ecommerce platform and also chat with a conversational agent via a graphical user interface present on the one or more user devices. Additionally, the disclosed system and method enables dynamic switch between the browse mode and the chat mode using the graphical user interface. The switching between the modes can happen from any mode to the other.

With the increasing use of chatbots and conversational AI agents, businesses are looking for new ways to engage customers and provide them with personalized and relevant experiences. One way to do this is by allowing shoppers to switch from a standard search function to a fully functional conversational AI agent and vice-versa. In one of the embodiments of the present invention, this is done using an integrated toggle switch within the standard search or browse function and within the chatbot function. Further, the chat bot can also be asked to switch the user back to standard search or browse function. In another embodiment of the same invention, the dynamic switching is done using a voice assistant.

The system as disclosed herein comprises a conversational agent, an ecommerce platform and a processor communicably coupled to a memory that stores one or more large language model based Generative AI modules. Throughout the disclosure the term “conversational agent” or the “artificial intelligence enabled chat bot” refers to a software module functionally operable to output text/audio response on basis of an input prompt from a user interacting with the ecommerce platform. Throughout the disclosure, the term product had been used without limitation. The word product is to be synonymously read and understood as product and or service. Thus a product page refers to a product page and/or a service page.

Additionally, in another embodiment of the same disclosure, the disclosed method and system keeps track of the user history while browsing through the ecommerce platform and accordingly teaches the conversational Artificial Intelligence enabled chat bot, to prompt relevant questions and answers while the user is in chat mode.

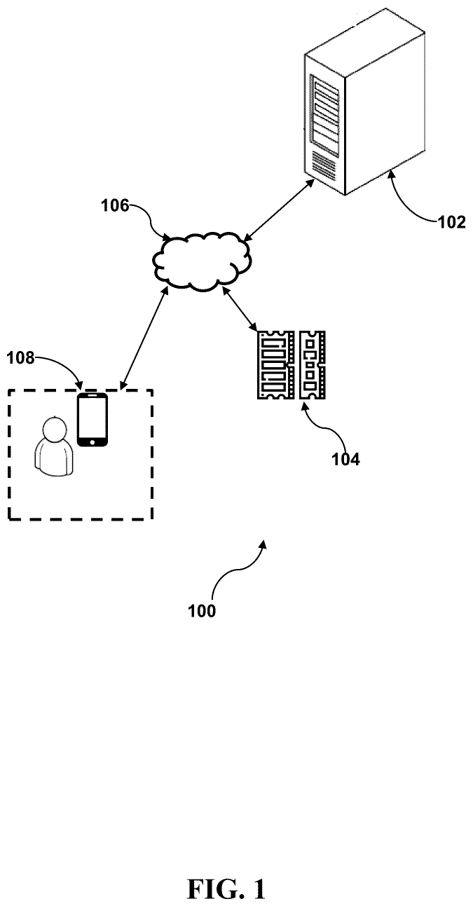

Referring to FIG. 1, the system 100 comprises a processor 102, a memory device 104 comprising executable non-transitory machine readable instructions wherein the processor 102 is configured to execute the said machine readable instructions. The processor 102 is configured to enable the conversational agent to perform various method steps. The processor 102 communicably coupled with the memory 104 via a data communication network 106. The user browses through the online e-commerce platform and enables the chat mode, provides inputs through one or more user devices 108 communicably coupled to the processor 102 via the data communication network 106.

The system 100 for dynamically switching between browsing and chatting in an online e-commerce platform, the system comprising: a processor 102 configured to execute non-transitory machine readable instructions, wherein the processor 102 is configured to enable a user to browse through an online e-commerce platform by starting a current session using a user device 110. The processor is also configured to enable the user to switch to a chat mode with a conversational agent, wherein the chat mode is activated from and within a current online page in which the user is browsing in the online e-commerce platform in the current session. The processor is also configured to enable the conversational agent to receive from the memory device, one or more browsing history of the user, wherein the one or more browsing history of the user comprises a browsing history of the user in the current session. The processor is also configured to enable the conversational agent to prompt one or more relevant outputs in a conversational manner, based on the current online page in which the user is browsing in the online e-commerce platform and the one or more browsing history of the user. The processor is also configured to receive one or more inputs from the user; analyse the one or more inputs received by the user to identify one or more requirements of the user and also enable the user to resume browsing in the online e-commerce platform by redirecting the user to an appropriate page of the online ecommerce platform based on the identified one or more requirements of the user, by closing the chat mode.

Throughout the present disclosure, the term chat mode represents an interface using which the user can engage in a conversation with the conversational agent. In the chat mode, the user can ask questions to the conversational agent, and also provide answers to the questions prompted by the conversational agent. Further, throughout the present disclosure, the term browse mode or search mode refers to one or more users browsing or searching through the online ecommerce platform. The browse mode includes the one or more different pages of the online ecommerce platform.

In one of the embodiments of the same invention, the system 100 comprises a processor 102 wherein the processor 102 is further configured to track one or more activities of the user on the online e-commerce platform in the current session and update the browsing history of the user in the current session, in the memory device. In another embodiment of the same invention, the browsing history of the user in the current session comprises one or more searches performed by the user in the online ecommerce platform.

As an illustration, the user may be browsing through different products and/or services in the current session and may have added a few products to his cart. The user may also have read a few reviews regarding a few products. Further, the user may have used different keywords for searching for the products. All of these activities are tracked and stored in the memory device as part of browsing history in the current session. The same is analysed using a proprietary algorithm by the processor and it predicts the probable products or services that the user may be searching for and accordingly, the relevant output is prompted by the conversational agent.

In another embodiment of the same invention, when the user has just started browsing in the online ecommerce platform, then the conversation agent prompts standard welcome message and asks the user few questions to understand the user's requirements.

In another embodiment of the same invention, the processor 102 is further configured to update the browsing history of the user in the current session based on the identified one or more requirements of the user, in the memory device.

In another embodiment of the same invention, the one or more browsing history of the user comprises one more browsing history of the user in one or more previous sessions of browsing done by the user. The same was tracked by the processor during the user's previous browsing sessions and stored in the memory device. This information is also used to prompt relevant outputs by the conversational agent, resulting in a personalised online shopping experience.

In another embodiment, the browsing history may also include the browsing history of other users in a particular relevant demography. This may also be used to prompt relevant and trending products and services by the conversational agent.

In various embodiments of the present invention, the one or more relevant outputs prompted by the conversational agent comprises one or more text outputs and in some other embodiments the one or more relevant outputs prompted by the conversational agent comprises one or more speech outputs. Some embodiments without limitation may have both or other forms of outputs as well, such as video, etc. The user is allowed to opt the type of output to be prompted. This helps the user to have a personalised experience because some users prefer voice based conversation and some prefer typing.

Similarly, in different embodiments of the present invention, one or more relevant outputs prompted by the conversational agent comprises one or more product or service recommendations, reviews of the products, characteristics of the products, etc. The same depends on the inputs provided by the users and their requirements.

Further, various other embodiments of the same invention also allows the one or more inputs from the user comprises one or more text inputs, one or more speech inputs and without limitation, various other forms of inputs such as touch based, video, product scanning, bar code scanning, etc.

Without limiting the scope of the present invention, the present invention solves various problems associated with existing online platforms. Shoppers aren't sure what they want. They may want the conversational agent to suggest something to them to get started exploring a catalog or platform. This may involve the conversational agent or the chat bot asking a few questions to understand shoppers' preferences including but not limited to their budget, suitability criteria, type of products they want etc. Thus this requires switching between browse mode to chat mode and back to browse mode.

In another embodiment, the system and method disclosed enable users to compare one or more products that may have seen/short listed, for example, how they compare with one other or if there are better options available. A conversational agent can help answer such questions, in the middle of browsing mode, when the user dynamically switches to chat mode. Additionally, users may have specific questions about the quality of the product or around suitability criteria (e.g. allergy, suitability around gender, age, size, weather, events, occasions etc.) which a conversational agent can help answer.

In another embodiment of the same invention, it enables the users to identify to identify other available options of the products (e.g. color, size, material etc) for the product they might have seen in the search results or anywhere on the website. In this case, switching to a conversational agent can help shoppers ask questions around the same and explore other available options in the catalogue.

In another embodiment of the same invention, the system discloses a method for tracking delivery of the products and also enables the user with real time updates. Additionally, while browsing or online shopping, a user may have questions around the delivery mode, timings, unlisted discounts, payments methods, returns etc. The user is enabled to find out the details by quickly switching to chat mode wherein the chat bot can answer such questions specific to the product or as per the general policy offered by the store.

Additionally, optionally, the present system and method also allows the user to get unbiased opinions or reviews of other shoppers buying the same or similar products. For example, how others have used it, what they see as pros and cons of the products, about their experience of delivery, returns etc. In a typical ecommerce website, the user has to manually go through the reviews. However, in the present system, the user can directly switch to chat mode and ask the chat bot for the relevant data and find answers to the specific questions, collect information around the shopper's own preferences and suggest products matching others' opinions.

In another embodiment of the same invention, the conversational agent or the chat bot can help users while they are still browsing by proactively offering help and answering any questions they may have and allowing them to switch to the chat mode. This can help reduce bounce rates and increase engagement, as shoppers are more likely to stay on the website or mobile app if they feel that they have access to someone answering their questions in a natural human language.

Even though conversational agents are becoming very powerful at understanding natural language, a shopper may want to switch back to the search mode/come out of the chat mode. This is another problem in the existing chat modes or chat options in the current ecommerce platforms. For example, shoppers may know exactly the product SKU code, product name or specific keywords they had used in the past to get to a desired product results. It may also be possible that the conversational agent is falling short of understanding shoppers' language and shopper may want to return to the standard non-conversational search interface. The disclosed system and method allows the user to switch back to the standard search or browse mode whenever the user desires. In such scenarios, the option to switch back to quick search allows shoppers to continue their search independently or try a different search query that may provide better results. This ensures that shoppers are not left feeling frustrated or confused, which can negatively impact their overall experience.

Additionally, offering a switch back to quick search can also help businesses gather valuable insights into the types of questions or queries that the conversational agent is unable to answer. This can help them identify knowledge gaps and improve the conversational agent's capabilities over time, ensuring that it becomes increasingly effective and efficient in helping shoppers.

Additional or less units can be included without deviating from the novel art of this disclosure. In addition, each unit can include any number and combination of sub-units, and systems, implemented with any combination of hardware and/or software units.

Throughout more disclosure the term “user device” refers to devices such as, but not limited to, a mobile phone, tablet, a laptop, a personal computer connected to a widely accessible network such as the Internet, any portable computing device connected to a widely accessible network such as the Internet, or any graphical user interface enabling a user to enter an input, a portable communication device, or a personal digital assistant connected to the one or more data communication network. The one or more user devices 108 may comprise any type of computing device, such as a desktop computer system, a laptop, cellular phone, a smart device, a mobile telephone, a tablet style computer, or any other device capable of wireless or wired communication. In some implementations, the one or more client devices are configured to interact with the processor 102 via an application, such as a web browser or a native application, residing on the client device.

Method steps of the invention may be performed by one or more computer processors executing a program tangibly embodied on a computer-readable medium to perform functions of the invention by operating on input and generating output. Suitable processors include, by way of example, computers, laptops, mobile phones, both general and special purpose microprocessors.

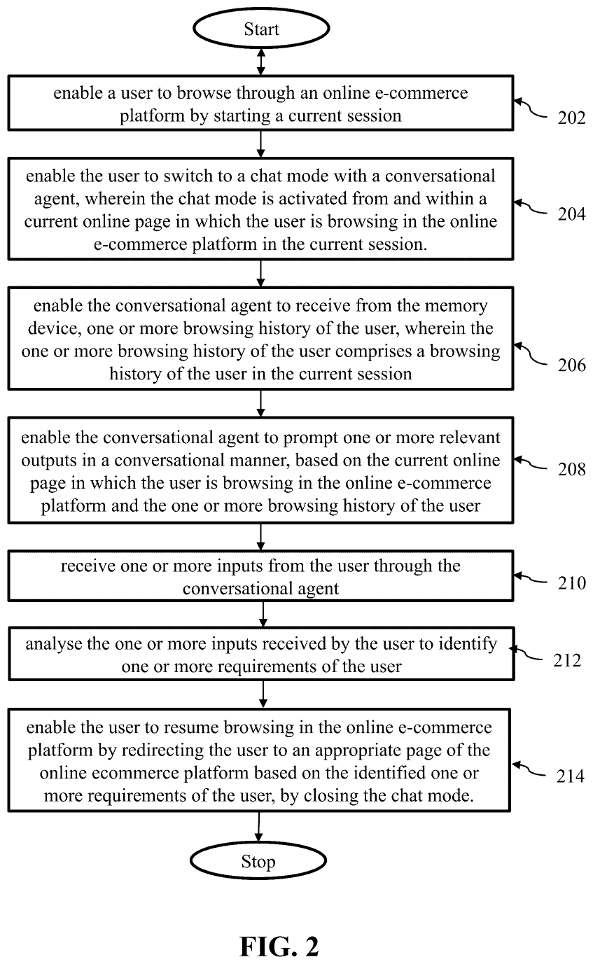

Another embodiment of the present invention discloses a computer implemented method for dynamically switching between searching and chatting in an online e-commerce platform comprising of various method steps. FIG. 2 depicts the different method steps in the present disclosure. At step 202, the processor enables a user to browse through an online e-commerce platform by starting a current session. At step 204, the processor enables the user to switch to a chat mode with a conversational agent, wherein the chat mode is activated from and within a current online page in which the user is browsing in the online e-commerce platform in the current session. At step 206, the processor enables the conversational agent to receive from the memory device, one or more browsing history of the user, wherein the one or more browsing history of the user comprises a browsing history of the user in the current session. At a step 208, the processor enables the conversational agent to prompt one or more relevant outputs in a conversational manner, based on the current online page in which the user is browsing in the online e-commerce platform and the one or more browsing history of the user. At step 210, the processor receives one or more inputs from the user through the conversational agent. At step 212, the processor analyses the one or more inputs received by the user to identify one or more requirements of the user. At step 214, the processor enables the user to resume browsing in the online e-commerce platform by redirecting the user to an appropriate page of the online ecommerce platform based on the identified one or more requirements of the user, by closing the chat mode.

Another embodiment of the present invention discloses One or more non-transitory storage media comprising computer-executable instructions that, when executed by a processor 102, causes the processor 102 to: enable a user to browse through an online e-commerce platform by starting a current session; enable the user to switch to a chat mode with a conversational agent, wherein the chat mode is activated from and within a current online page in which the user is browsing in the online e-commerce platform in the current session; enable the conversational agent to receive from the memory device, one or more browsing history of the user, wherein the one or more browsing history of the user comprises a browsing history of the user in the current session; enable the conversational agent to prompt one or more relevant outputs in a conversational manner, based on the current online page in which the user is browsing in the online e-commerce platform and the one or more browsing history of the user; receive one or more inputs from the user; analyse the one or more inputs received by the user to identify one or more requirements of the user; and enable the user to resume browsing in the online e-commerce platform by redirecting the user to an appropriate page of the online ecommerce platform based on the identified one or more requirements of the user, by closing the chat mode.

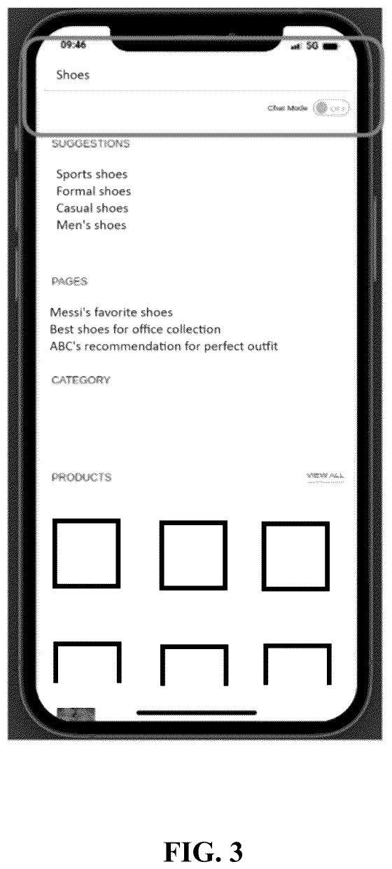

FIG. 3 depicts a sample dynamic HTML page displayed on the graphical user interface of the smartphone before activating the chat mode in accordance with one of the embodiments of the present invention. In this search mode the user can search for specific products by themselves. There is an option available for the user to switch to the chat mode and engage with the conversational agent.

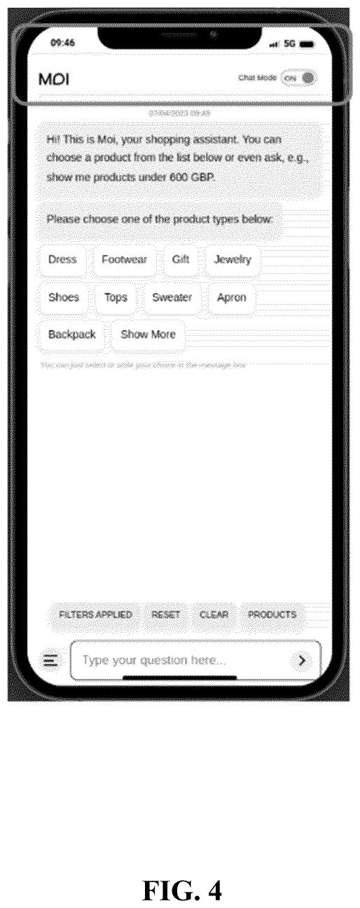

FIG. 4 depicts a sample dynamic HTML page displayed on the graphical user interface of the smartphone after activating the chat mode in accordance with one of the embodiments of the present invention. This is an illustration of an exemplary embodiment of the present invention wherein the user has entered the chat mode and can converse with the conversational agent and ask all the queries or information needed or specific products that suit their requirements.

As an example of the various embodiments of the present invention, without limiting the scope of the invention, the user is searching shoes. He will enter the required criteria for the shoes in the search bar, such as sports shoes. Typically, an ecommerce platform generates a list of sports shoes available. The user can select one particular shoe and a detailed product page opens. In the present invention, the user may seek additional information regarding the sport shoes by switching to sports shoes. Alternatively, the conversational agent may seek additional information from the user regarding what all characteristics he is looking for in the shoes, for example, running shoes, football shoes, etc, size, colour and such other information and the conversational agent can prompt the appropriate products in the online ecommerce platform and the user can then be redirected to its respective pages and the conversational agent is then closed.

Throughout this disclosure, the term online ecommerce platforms has been used, without limitation. The same may be applicable to any type of online platforms, websites, internet based applications and other internet based interfaces. Without limitation, it may refer to not just ecommerce and shopping but for other purposes as well. For illustration purposes only, without limiting the scope of the invention, the system and methods can be integrated with online gaming platforms and websites, food ordering and review applications, online stock markets, internet banking, etc.

In an alternative embodiment of the same invention, the said invention is built using a distributed ledger based platform such as blockchain. The system and method facilitates online ecommerce shopping using cryptocurrency. Additionally, smart contracts can be added wherein the smart contracts would facilitate buying and selling based on the set conditions. Having a blockchain based platform ensures that the transactions can be tracked and no one can mis-use the present system.

Beneficially, some of the embodiments of the present technical solution may also be modified to provide benefits including but not limited to (a) providing a single platform for browse and chat in ecommerce; (b) closest experience to a real life shopping experience in a physical store with the help of a customer executive (c) easy shopping experience because of the questions and answers prompted by the chat bot is based upon the user's history and specific to products.

Any of the software components or functions described in this application may be implemented as software code to be executed by a processor 102 using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or flash memory, USB and the like or in cloud storages. The computer readable medium may be any combination of such storage or transmission devices.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It will be understood that the application is not limited to the embodiments disclosed, but is capable of numerous rearrangements, modifications, and substitutions as set forth.

At least portions of the functionalities or processes described herein can be implemented in suitable computer-executable instructions. It will be appreciated that features of the present disclosure are susceptible to being combined in various combinations and additional features may be introduced without departing from the scope of the present disclosure.

1. A system for dynamically switching between searching and chatting in an online e-commerce platform, the system comprising:
a processor configured to execute non-transitory machine-readable instructions, wherein the processor is configured to:
enable a user to browse through an online e-commerce platform by starting a current session using a user device;
enable the user to switch to a chat mode with a conversational agent, wherein the chat mode is activated from and within a current online page in which the user is browsing in the online e-commerce platform in the current session;
enable the conversational agent to receive from the memory device, one or more browsing history of the user, wherein the one or more browsing history of the user comprises a browsing history of the user in the current session;
enable the conversational agent to prompt one or more relevant outputs in a conversational manner, based on the current online page in which the user is browsing in the online e-commerce platform and the one or more browsing history of the user;
receive one or more inputs from the user;
analyse the one or more inputs received by the user to identify one or more requirements of the user; and
enable the user to resume browsing in the online e-commerce platform by redirecting the user to an appropriate page of the online ecommerce platform based on the identified one or more requirements of the user, by closing the chat mode.

2. The system of claim 1 wherein the processor is further configured to:
track one or more activities of the user on the online e-commerce platform in the current session; and
update the browsing history of the user in the current session, in the memory device.

3. The system of claim 1 wherein the processor is further configured to update the browsing history of the user in the current session based on the identified one or more requirements of the user, in the memory device.

4. The system of claim 1 wherein the browsing history of the user in the current session comprises one or more searches performed by the user in the online ecommerce platform.

5. The system of claim 1 wherein the one or more browsing history of the user comprises one more browsing history of the user in one or more previous sessions.

6. The system of claim 1 wherein the one or more relevant outputs prompted by the conversational agent comprises one or more text outputs.

7. The system of claim 1 wherein the one or more relevant outputs prompted by the conversational agent comprises one or more speech outputs.

8. The system of claim 1 wherein the one or more relevant outputs prompted by the conversational agent comprises one or more product recommendations.

9. The system of claim 1 wherein the one or more inputs from the user comprises one or more text inputs, one or more speech inputs.

10. The system of claim 1 wherein the conversational agent is enabled with artificial intelligence.

11. A computer implemented method for dynamically switching between searching and chatting in an online e-commerce platform, the method comprising:
enabling a user to browse through an online e-commerce platform by starting a current session;
enabling the user to switch to a chat mode with a conversational agent, wherein the chat mode is activated from and within a current online page in which the user is browsing in the online e-commerce platform in the current session;
enabling the conversational agent to receive from the memory device, one or more browsing history of the user, wherein the one or more browsing history of the user comprises a browsing history of the user in the current session;
enabling the conversational agent to prompt one or more relevant outputs in a conversational manner, based on the current online page in which the user is browsing in the online e-commerce platform and the one or more browsing history of the user;
receiving one or more inputs from the user through the conversational agent;
analysing the one or more inputs received by the user to identify one or more requirements of the user; and
enabling the user to resume browsing in the online e-commerce platform by redirecting the user to an appropriate page of the online ecommerce platform based on the identified one or more requirements of the user, by closing the chat mode.

12. The method of claim 11 wherein the processor is further configured to:
track one or more activities of the user on the online e-commerce platform in the current session; and
update the browsing history of the user in the current session, in the memory device.

13. The method of claim 11 wherein the processor is further enabled to update the browsing history of the user in the current session based on the identified one or more requirements of the user, in the memory device.

14. The method of claim 11 wherein the browsing history of the user in the current session comprises one or more searches performed by the user in the online ecommerce platform.

15. The method of claim 11 wherein the one or more browsing history of the user comprises one more browsing history of the user in one or more previous sessions.

16. The method of claim 11 wherein the one or more relevant outputs prompted by the conversational agent comprises one or more text outputs, one or more speech outputs.

17. The method of claim 11 wherein the one or more relevant outputs prompted by the conversational agent comprises one or more product recommendations.

18. The method of claim 11 wherein the one or more inputs from the user comprises one or more text inputs, one or more speech inputs.

19. The method of claim 11 wherein the conversational agent is enabled with artificial intelligence.

20. One or more non-transitory storage media comprising computer-executable instructions that, when executed by a processor, causes the processor to:
enable a user to browse through an online e-commerce platform by starting a current session;
enable the user to switch to a chat mode with a conversational agent, wherein the chat mode is activated from and within a current online page in which the user is browsing in the online e-commerce platform in the current session;
enable the conversational agent to receive from the memory device, one or more browsing history of the user, wherein the one or more browsing history of the user comprises a browsing history of the user in the current session;
enable the conversational agent to prompt one or more relevant outputs in a conversational manner, based on the current online page in which the user is browsing in the online e-commerce platform and the one or more browsing history of the user;
receive one or more inputs from the user;
analyse the one or more inputs received by the user to identify one or more requirements of the user; and
enable the user to resume browsing in the online e-commerce platform by redirecting the user to an appropriate page of the online ecommerce platform based on the identified one or more requirements of the user, by closing the chat mode.
